(19) United States
(12) Patent Application Publication
(10) Pub. No.: US 2022/0138442 A1
(43) Pub. Date: May 5, 2022

(54) Sensor Array

(71) Applicant: Leuze electronic GmbH + Co. KG, Owen/Teck (DE)

(72) Inventor: Herbert Köbel, Owen/Teck (DE)

(21) Appl. No.: 17/505,668

(22) Filed: Oct. 20, 2021

(30) Foreign Application Priority Data
Nov. 4, 2020 (EP) 20205732.9

(51) Int. Cl. G06K 7/00; G06K 7/10; G06K 7/14

(52) U.S. Cl. CPC G06K 7/0008; G06K 7/1456; G06K 7/10574; G06K 7/10861

(57) ABSTRACT

A sensor array (1) having at least one code reader that is designed for reading codes (3), and having at least one computing unit (7). The code reader with the computing unit (7) constitutes an RFID emulator sensor (2), in that the code reader and the computing unit (7) are connected via an emulator data channel (9), via which exclusively subsystem data and/or transponder emulator data can be written to a memory range of a memory unit of the computing unit (7) by the code reader or subsystem data and/or transponder emulator data can be read from this memory unit by means of the code reader, wherein this memory range is defined by a code (3) read by the code reader.

### CROSS REFERENCE TO RELATED APPLICATIONS

This application claims the priority of EP 20205732.9 filed on 2020 Nov. 4; this application is incorporated by reference herein in its entirety.

### BACKGROUND

The invention relates to a sensor array according to the preamble of claim 1.

Such sensor arrays can be constituted by code readers, by means of which codes arranged on objects can be read. The code readers are generally designed as optical sensors, such as in the form of scanners or camera sensors. Codes, especially 1D or 2D barcodes are optically scanned and decoded using the code readers having this design. The objects to which codes have been applied are identified by being read by the code readers. This can be exploited for object tracking purposes, especially in complex automation plants.

Moreover, RFID systems are in use for object identification and object tracking. Objects are then equipped with transponders, each of which has a local memory. This memory can store more than merely an identification of the object. Rather, additional object data, such as the size or loading status of an object can be stored. The data stored in the transponders can be read out by RFID reader units, for example, to use said data for automation processes in an automation plant. Moreover, object data can be written to the transponder using the RFID reader units.

### SUMMARY

The invention seeks to solve the problem of providing a sensor array of the aforementioned type that has a high level of functionality.

To solve this problem, the features of claim 1 are provided. Advantageous embodiments and useful further developments of the invention are described in the dependent claims.

### DETAILED DESCRIPTION

The invention relates to a sensor array with at least one code reader that is designed for reading codes, and at least one computing unit. The computing unit with the code reader constitutes an RFID emulator sensor. The code reader and the computing unit are connected via an emulator data channel. Only subsystem data and/or transponder emulator data can be read by the code reader via the emulator data channel to a memory range of a memory unit of the computing unit or subsystem data and/or transponder emulator data can be read from this memory unit by means of the code reader. This memory range is defined by a code read by the code reader.

The basic idea behind the invention is therefore to combine the advantages of optical sensors in the form of code readers, which enable cost-effective object identification, with the advantages of an RFID system, which enables decentralized, mobile data storage in the transponders.

An object identification can be performed significantly more cost-effectively with the code readers of the sensor array according to the invention than with RFID systems.

The simulation, i.e. emulation, of an RFID sensor is accomplished according to the invention in that the at least one code reader is connected to the at least one computing unit via an emulator data channel, wherein this emulator data channel is used solely, i.e. exclusively, for the reading of transponder emulator data by the code reader to a memory range of a memory unit or reading transponder emulator data from the memory range of the memory unit.

Alternatively or additionally, a reading of subsystem data both ways is also possible. Subsystem data is data of the code reader itself or data of units that interact with the code reader, such as actuators, controllers and the like. Without limiting the generality, the following refers solely to the transponder emulator data.

Generally, an indirect addressing is performed such that the code that is read by the code reader defines this memory range of the memory unit.

The decentral memory function of an RFID sensor is thereby emulated using the RFID emulator sensor according to the invention.

It is essential that the computing unit and the emulator data channel be used exclusively for emulating the RFID emulator sensor.

Moreover, the so constituted RFID emulator sensor can be connected to a host system, i.e. a host computer of an automation system or the like, so that it can fulfill automation functions.

The emulator data channel can be in the form especially of a logic channel, the data transfer through which occurs on the same physical cable as the connection to the host system.

It is advantageous for an RFID emulator software forming the control and evaluation unit of the RFID emulator sensor to be implemented in the one computing unit or in each of the computing units.

All functions for emulating the RFID emulator sensor are performed by the RFID emulator software.

It is expedient for an RFID emulator user interface to be provided for the RFID emulator software.

During a read operation, the RFID emulator sensor reads the code and sends the code to the computing unit. The RFID emulator software in the computing unit reads out the memory ranges defined by the code and sends the transponder emulator data back to the RFID emulator sensor. The RFID emulator sensor packages the data according to an AutoID profile and subsequently transmits this transponder emulator data to the superordinate host system.

The procedure is similar for a write operation. The transponder emulator data to be written is transmitted by the RFID emulator sensor to the computing unit and stored there.

In general, the data that can be stored in the computing unit can be object data relating to the object labeled with the respective code. The object data can characterize the object with regard to properties or size. The object data can also be loading statuses or other features.

Moreover, the transponder emulator data can be sensor data.

In this case, the sensor data is generated by sensors assigned to the code reader.

Such sensors can be temperature sensors, pressure sensors and the like, that ascertain relevant characteristic variables for an object.

Furthermore, other characteristic variables from the automation world, such as weight, volume, dimensions, position, location or overhang, can be integrated through sensor signals of the sensors. In general in this regard, the RFID emulator sensor addresses the other sensors via an additional logic interface, a multi-sensor interface, in order to assign their data to the object in a time-synchronous manner. For example, a practical manifestation is the integration of 10-link sensors. 10-link sensors support many diverse measurement principles and data within automation technology. They can be addressed and integrated for data purposes directly or via an 10-link master. Solutions with an additional physical supplementary interface and direct integration via field buses and Ethernet networks as well as radio communications are alternatively conceivable.

It is advantageous for transponder emulator metadata to be assigned to the transponder emulator data.

The transponder emulator metadata is assigned to the transponder emulator data. The transponder emulator metadata can be especially quality and statistical data that characterizes the read operations performed with the RFID emulator sensor, i.e. code reader. This transponder emulator metadata is captured in a time-indexed manner and assigned to the transponder emulator data.

It is advantageous for the memory unit to constitute a database.

The memory unit or, respectively, the database can be segmented and scaled as desired using the RFID emulator software.

According to an advantageous embodiment, the communication between the code reader and the computing unit takes place via a secure communication interface.

The communication interface is designed for configuring various communication and security settings of the RFID emulator sensors and transponder emulator data.

It is further advantageous for a lock mechanism to be provided as access protection for the data stored in the memory unit.

The local transport of plant-relevant information must be secured against unauthorized access. Therefore, security mechanisms are provided for each RFID emulator sensor. The data on an RFID emulator sensor can be protected by security certificates or by standardized authentication procedures used in information technology, such as passwords. Moreover, the communication interface from the host system to the RFID emulator sensor has security features in order to prevent the password and data contents from being read out there as well. The OPC UA communication standard, with the companion standard (CS) AutoID, is suitable for the communication between host system and an RFID emulator sensor. OPC UA is a communication system, which according to the [German] Federal Office for Information Security, enables reliable communication in automation technology. In conjunction with the standardization of the RFID emulator sensors in an AutoID profile, universal useability results.

It is especially advantageous for the entire system, i.e. the entire sensor array according to the invention with all assigned units, to be protected by authentication mechanisms, by which means unauthorized access is generally prevented.

The read as well as write data can be protected via the lock mechanism (mechanism for blocking (unauthorized) access). Generally, security is provided in the form of a password. To do so, the RFID emulator sensor reads the code as usual, i.e. the code information of the code, and forwards this along with the password to the RFID emulator software in the computing unit. The data ranges in the memory unit for this code information are thereby blocked and thereafter can only be read or written with the password. The RFID emulator software acknowledges the status to the RFID emulator sensor, which in turn acknowledges the status to the host system.

Moreover, changing a password is supported. In this procedure as well, first the code is read before the old and new password are forwarded to the RFID emulator software, evaluated and stored. An acknowledgement of the processing is sent to the host system via the RFID emulator sensor.

According to an advantageous further development, the sensor array can have multiple code readers and therefore multiple RFID emulator sensors. This is advantageous especially in the control and monitoring of complex automation systems.

According to a first embodiment, the sensor array has multiple code readers that are assigned to a computing unit, wherein each code reader with the computing unit constitutes an RFID emulator sensor.

Moreover, it is possible for the sensor array to have multiple code readers that are assigned to different computing units, wherein each code reader with the assigned computing unit constitutes an RFID emulator sensor.

In general, it is possible for the computing unit or a computing unit to be a cloud computer, a server or a local computer of an automation plant.

According to a first variant, the various computing units are connected via network routers.

Alternatively, the various computing units are connected via a cloud.

The use of cloud systems is especially suitable for complex plants, especially automation systems, that are distributed over multiple sites.

In such distributed systems, the RFID emulator software and the RFID emulator user interface can be provided on different computer units.

The RFID emulator user interface, especially, is provided in a cloud system.

It is useful for access to transponder emulator data and/or transponder emulator metadata stored in a memory unit to take place by means of an RFID emulator application logic.

It is advantageous for access to the RFID emulator software to be enabled via the RFID emulator user interface.

In this regard, addressing and/or administration of the RFID emulator software is enabled via the RFID emulator user interface.

An essential aspect in such complex systems is that means for synchronizing the memory unit or, respectively, database of the individual computing units are provided.

With this synchronization, a uniqueness of all RFID emulators is achieved, even if these RFID emulator systems are part of a wider network and possibly installed at different sites.

It is advantageous for the synchronization to occur via a database replication for the individual RFID emulator sensors, which is enabled by the RFID emulator software in the individual computing units or RFID emulator systems.

By means of the synchronization, changes in the data sets of the individual databases can be comprehensively tracked, especially in the form of transponder emulator metadata.

Moreover, additional advantageous functions can be realized with the synchronization, which functions can naturally be implemented accordingly in a simple system with just one RFID emulator sensor.

In this manner, capturing, configuration and administration of RFID emulator sensors occur via the RFID emulator software implemented, synchronized in the individual RFID emulator sensors.

Information, especially from individual RFID emulator sensors, can be compiled and exchanged with a cloud system.

The RFID emulator software of the RFID emulator sensors captures every connected RFID emulator sensor and stores it in a database.

The RFID emulator software detects deviations from previously stored RFID emulator sensors and labels and stores the changes.

The RFID emulator sensors must be accepted into a device network of the sensor array by the RFID emulator software at least once, by way of user inputs or trust measures in the form of security certificates. Successful acceptance must be preceded by a successful exchange and comparison of security features between the RFID emulator sensors and the RFID emulator software of a computing unit.

The RFID emulator software of one or all computing units stores via image all settings defined by parameters, configurations, access data, and the like, from all RFID emulator sensors of the device network.

Such archived data can be resaved in an RFID emulator sensor. The RFID emulator software can have a corresponding set of rules for doing so.

It is also possible to delete or destroy RFID emulator data.

Here as well, the code is first identified by means of the code reader. The code is sent from the RFID emulator sensor to the computing unit. The latter then deletes all data stored under this code. Generally, the deletion process is protected by a password. The host system must then send the password with the command and send it to the RFID emulator software. The processing is acknowledged by a status message sent to the host system. Although the code cannot be physically destroyed, all subsequent read operations are acknowledged to the host system as not read.

Moreover, the RFID emulator software can record and store status changes or statistical data from the RFID emulator sensor.

Moreover, an update of firmware of software units of RFID emulator sensors can be performed by means of the RFID emulator software.

The software updates can especially also be performed via external systems that are connected to the RFID emulator software of the computing unit.

In general, centralized access to stored transponder emulator data and transponder emulator metadata is possible via the RFID emulator software and the synchronized databases, wherein this data can be made visible, if necessary. This data can therefore be centrally administered, modified and configured, as well as deleted. This processing can occur at any time and does not require read access to RFID emulator sensors.

It is advantageous for the system according to the invention to be designed such that transponder emulator data and/or transponder emulator metadata can be administered, archived, evaluated or replicated by means of an RFID emulator application logic.

According to an advantageous embodiment, multiple code readers constitute a multiscan arrangement such that with them, a code can be read simultaneously from different directions. These code readers are interconnected within a logic network. Only one of these code readers with the assigned computing unit constitutes an RFID emulator sensor, wherein the code reader constituting the RFID emulator sensor simultaneously triggers the other code readers of the multiscan arrangement to perform read operations of a code. The first code read by one of the code readers is used for further processing.

Codes are scanned from different directions by the code readers arranged in the multiscan arrangement, whereby detection reliability is enhanced.

An essential aspect in this regard is that only one of these code readers constitutes an RFID emulator sensor and triggers the remaining code readers of the multiscan arrangement and evaluates the results of all code readers.

### BRIEF DESCRIPTION OF THE DRAWINGS

The invention is explained below based on the drawings. They show:

FIG. 1: A first exemplary embodiment of the sensor array according to the embodiment.

FIG. 2: A second exemplary embodiment of the sensor array according to the invention.

FIG. 3: A third exemplary embodiment of the sensor array according to the invention.

FIG. 4: A fourth exemplary embodiment of the sensor array according to the invention.

FIG. 5: A fifth exemplary embodiment of the sensor array according to the invention.

FIG. 6: A sixth exemplary embodiment of the sensor array according to the invention.

FIG. 7: A seventh exemplary embodiment of the sensor array according to the invention.

FIG. 8: An eighth exemplary embodiment of the sensor array according to the invention.

FIG. 9: A ninth exemplary embodiment of the sensor array according to the invention.

FIG. 10: A tenth exemplary embodiment of the sensor array according to the invention.

### DETAILED DESCRIPTION OF THE PREFERRED EMBODIMENTS

FIG. 1 shows a first exemplary embodiment of the sensor array 1 according to the invention. FIG. 1 shows the sensor array 1 in its simplest form.

The sensor array 1 comprises a code reader that is further developed according to the invention into an RFID emulator sensor 2. The code reader is implemented in the known fashion as an optical sensor, especially as a scanner or camera sensor, with which codes 3, especially 1D or 2D barcodes, can be read. The code 3 serves to identify an object upon which it is applied, i.e. the code 3 forms an ID code.

The RFID emulator sensor 2 is connected in the known fashion to a host system 4, i.e. connected to at least one host computer, which is, especially, part of an automation system. Generally, the RFID emulator sensor 2 searches its database for the object data and reads the corresponding data and then sends it to the host system 4. In particular, the codes 3 read by the RFID emulator sensor 2 are interpreted and the associated object data is supplied to the host system 4, especially for the purpose of performing automation tasks. To this end, the RFID emulator sensor 2 is connected to the host system 4 via a data cable 5.

The code reader is part of an RFID emulator system 6, which serves to simulate, i.e. emulate, the RFID emulator sensor 2.

The RFID emulator system has a computing unit 7 in which an RFID emulator software 8 is implemented. The computing unit 7, i.e. the RFID emulator software 8, is connected to the RFID emulator sensor 2 via an emulator data channel 9.

The emulator data channel 9 can be part of the physical data cable 5. The emulator data channel 9 forms a secure transmission path.

It is useful for the data transmission via the data cable 5 to be subject to the OPC UA communication standard with the companion standard (CS) AutoID. The emulator data channel 9 complies with this companion standard and is expanded to include additional service features.

For the code reader constituting the RFID emulator sensor 2, the function of an RFID sensor is emulated in that a memory unit, especially in the form of a database, is assigned to the code reader in the computing unit 7.

The memory unit or, respectively, database can be segmented or scaled as desired using the RFID emulator software 8.

The code 3 read by the code reader serves to indirectly address the memory unit for a reading in and out of data, which especially constitutes transponder emulator data in the form of object data. The object data is assigned to the object that is labelled with the code 3. Moreover, data can be constituted in the form of transponder emulator metadata assigned to the transponder emulator data. This transponder emulator metadata can be quality or statistical data that is captured in a time-indexed manner and assigned to the transponder emulator data.

When the code 3 is read for the first time, a memory object, i.e. memory range, is created in the memory, which memory object is referenced by the code 3.

During a subsequent read operation, the RFID emulator sensor 2 reads the code 3 and sends it to the RFID emulator software 8. The RFID emulator software 8 reads out the memory range in this code 3 and sends the data, i.e. transponder emulator data, and as the case may be, transponder emulator metadata, to the RFID emulator sensor 2. The RFID emulator sensor 2 packages this data according to the AutoID profile and sends it to the host system 4.

A write operation takes place in a corresponding manner, wherein in this case data is sent from the RFID emulator 2 to the computing unit 7 and stored in the memory range of the memory unit defined by the code 3.

With the write/read operations that use the memory unit, the functionality of an RFID sensor is fully emulated by the RFID emulator sensor 2.

It is advantageous for the data to be protected against unauthorized access by a lock mechanism, i.e. a blocking mechanism. It is advantageous for this protection to be implemented in the form of a password, which the RFID emulator sensor 2 sends to the computing unit 7 with the read code 3. The corresponding memory ranges

are therefore password-protected.

Moreover, the memory unit constitutes a database.

The communication between the code reader and the computing unit 7 takes place via a secure communication interface.

The RFID emulator software 8 constitutes not only a control and evaluation unit for emulating the functions of an RFID sensor.

Moreover, capturing, configuration and administration of the RFID emulator sensors 2 is performed by means of the RFID emulator software 8.

Furthermore, an update of firmware of software units of RFID emulator sensors 2 can be performed by means of the RFID emulator software 8.

In the sensor array 1 from FIG. 1, the computing unit 7 or a computing unit 7 can be a cloud computer, a server or a local computer of an automation plant.

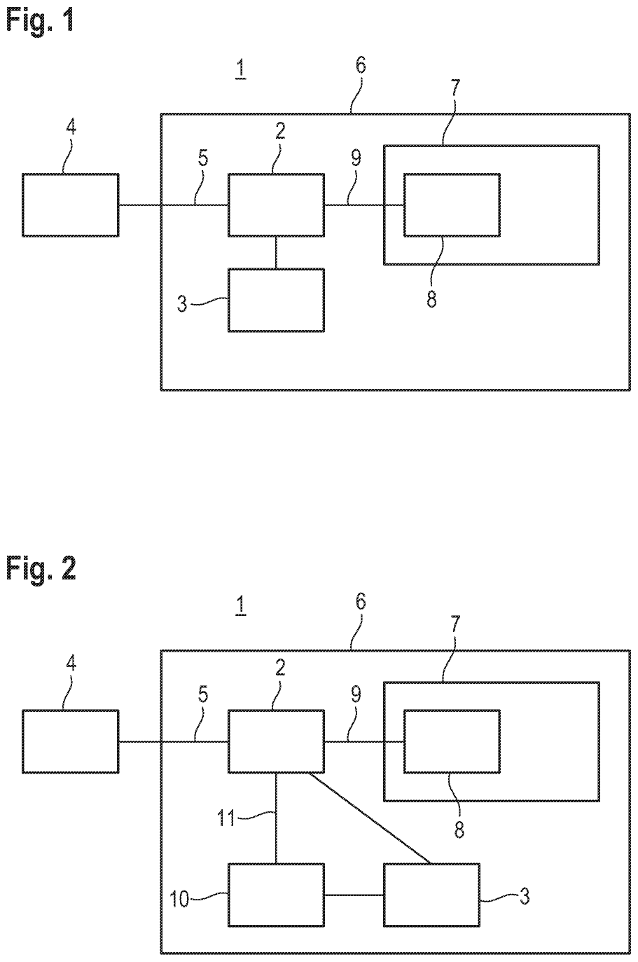

The embodiment from FIG. 1 describes the basic functions of the sensor array 1 according to the invention, which are also realized in the other sensor arrays 1 from FIGS. 2 to 9.

FIG. 2 shows a further development of the embodiment from FIG. 1 that is expanded in that the code reader constituting the RFID emulator sensor 2 is connected to an additional code reader 10 via a logic network 11 and together with this, constitutes a multiscan arrangement.

Multiple code readers constitute a multiscan arrangement especially such that with them, a code 3 can be read simultaneously from different directions, wherein the code reader is networked in a logic network 11 and only one of these code readers, with the assigned computing unit 7, constitutes an RFID emulator sensor 2, wherein the code reader constituting the RFID emulator sensor 2 simultaneously triggers the other code readers 10 of the multiscan arrangement to perform read operations of a code 3. The first code 3 read by one of the code readers is used for further processing.

Moreover, multiple spaced codes 3 can be read by the code readers of the multiscan arrangement.

The codes 3 can have different initial strings but the same end character strings.

Based on the read code 3, a filtering is performed or an object orientation is determined.

Moreover, different fragments of a code 3 are read by the code readers of the multiscan arrangement, wherein the fragments are compiled in an RFID emulator sensor 2 or in a computing unit 7, 7′ to detect the code 3.

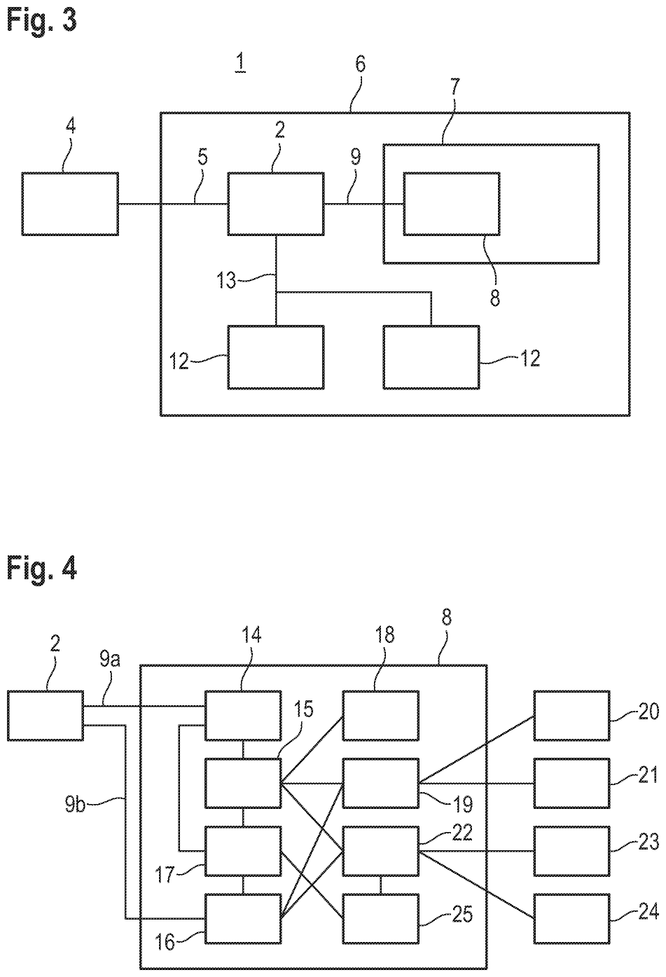

FIG. 3 shows an expansion of the embodiment from FIG. 1 that is expanded in that additional sensors 12 are assigned to the RFID emulator sensor 2. The additional sensors 12 are connected to the RFID emulator sensor 2 via a multisensor interface 13. It is advantageous for the additional sensors 12 to be 10-link sensors that can be addressed via an 10-link master. Moreover, the multisensor interface 13 can be realized in the form of a field bus, an Ethernet network or by a radio interface.

Sensor data that records, for example, characteristic variables of the object, such as weight, volume, position, location or overhangs, are captured by the additional sensors 12 as transponder emulator data. Transponder emulator metadata can be assigned to this sensor data as well.

FIG. 4 shows an exemplary embodiment that shows a further development of the sensor array 1 from FIG. 1.

The RFID emulator sensor 2 is connected to the RFID emulator software 8 via the secure communication interface elements 9a, 9b constituting the emulator data channel 9.

The RFID emulator software 8 has a control and evaluation unit for emulating the function of an RFID sensor, which control and evaluation unit has an RFID emulator transponder logic 14, an RFID emulator application logic 15 and an RFID emulator sensor logic 16 as software modules.

Additionally, an RFID emulator database 17 constituting the memory unit is provided. Moreover, an RFID emulator user interface 18 is provided.

It is advantageous for transponder emulator data and/or transponder emulator metadata stored in a memory unit to be accessed by means of an RFID emulator application logic 15.

Furthermore, a programming interface 19 is provided via which the RFID emulator application logic 15 can be addressed and which is connected to an external directory service 20 and an additional external system 21.

A connection to a cloud system 23 and to a CRM system 24, i.e. a customer relationship management system, is established by means of an RFID emulator cloud connector 22.

Usage features can be evaluated in the CRM system 24 for product improvements, especially for business models.

Moreover, an RFID emulator database synchronization module 25 is provided. The RFID emulator database synchronization module 25 serves to synchronize databases of different RFID emulator softwares 8 for different computing units 7 in complex sensor arrays 1 with multiple RFID emulator sensors 2.

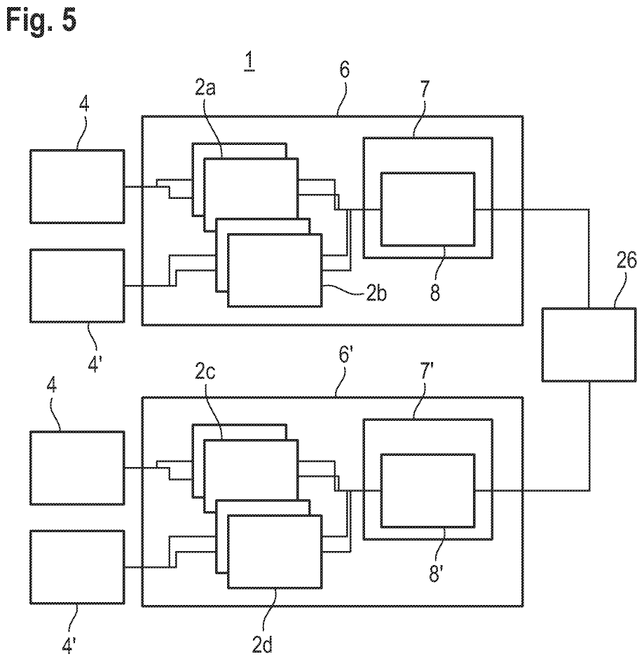

Such a complex sensor array is shown in FIG. 5.

FIG. 5 shows two identically constructed RFID emulator systems 6, 6′, each with two RFID emulator sensors 2a, 2b, respectively, 2c, 2d, each of which is connected to a computing unit 7, 7′ with an RFID emulator software 8, 8′.

The RFID emulator systems 6, 6′ are connected to host systems 4, 4′. The RFID emulator systems 6, 6′ are coupled via a network router 26. The number of components shown is not compulsory, of course.

This variant is especially well suited for multiple RFID emulator systems 6, which are housed at one site.

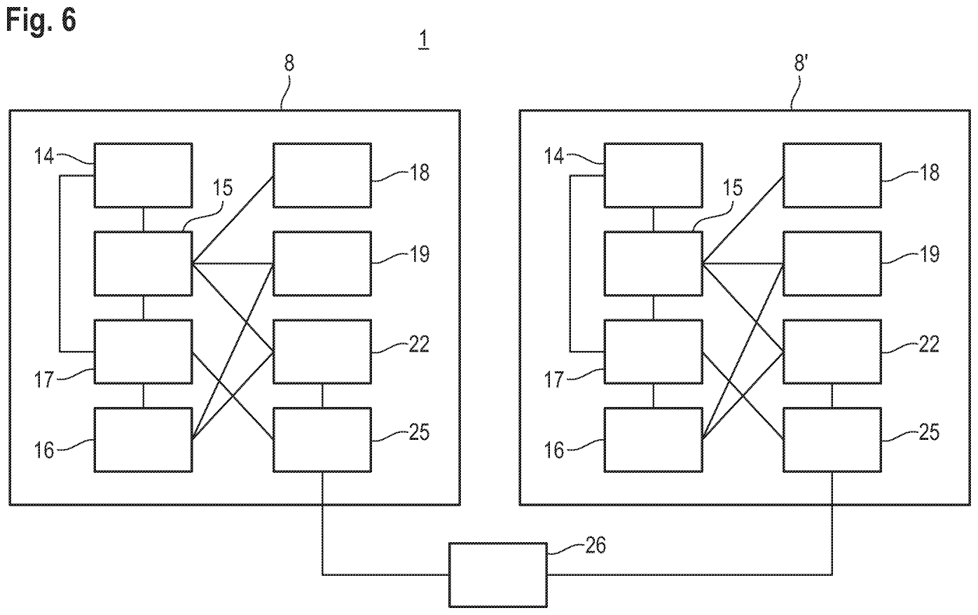

FIG. 6 shows a concrete embodiment of the sensor array 1 from FIG. 5 with the system components according to FIG. 4.

The RFID emulator database synchronization modules 25 are connected to the network router 26 and ensure synchronization of the RFID emulator systems 6, 6′ by replicating the RFID emulator databases 17. A uniqueness of all RFID emulator sensors 2a-2d and their data of the sensor array 1 is achieved thereby.

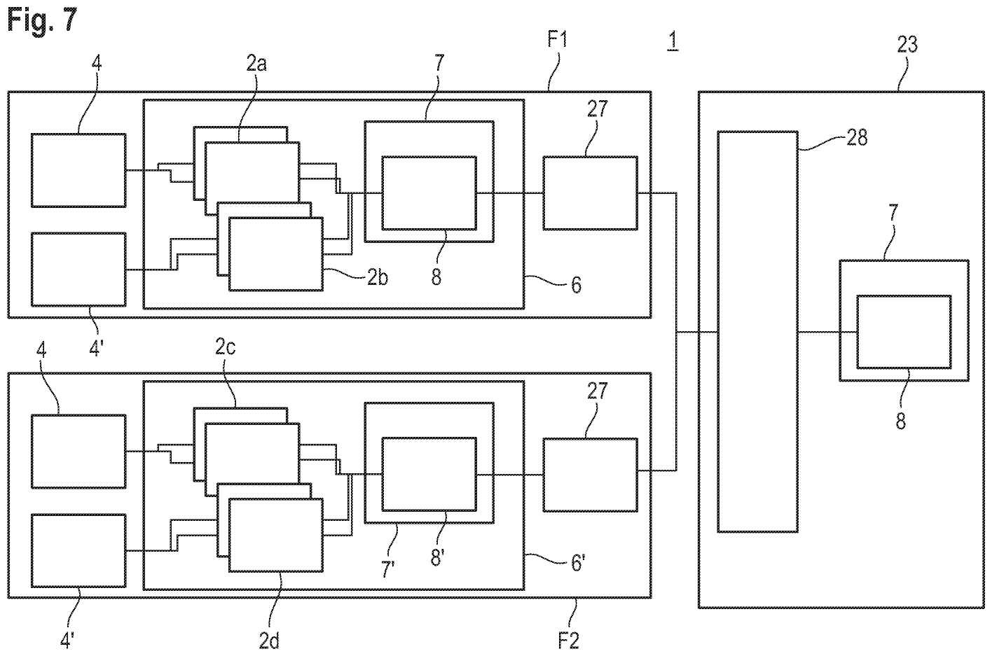

FIG. 7 shows another exemplary embodiment of the sensor array 1 according to the invention. It differs from the embodiment from FIG. 5 in that the RFID emulator systems 6, 6′ are connected via a cloud system 23. The number of the RFID emulator systems 6, 6′ shown can be chosen as desired.

The RFID emulator systems 6, 6′ can be arranged at various sites, especially in different factories F1, F2. Each RFID emulator system 6, 6′ has a firewall 27 for secure coupling to the cloud system 23.

A digital map is created in the cloud system 23 for the computing units 7 with the RFID emulator software 8 implemented therein, including the RFID emulator database 17 present therein, wherein a cloud infrastructure 28 is used for this purpose.

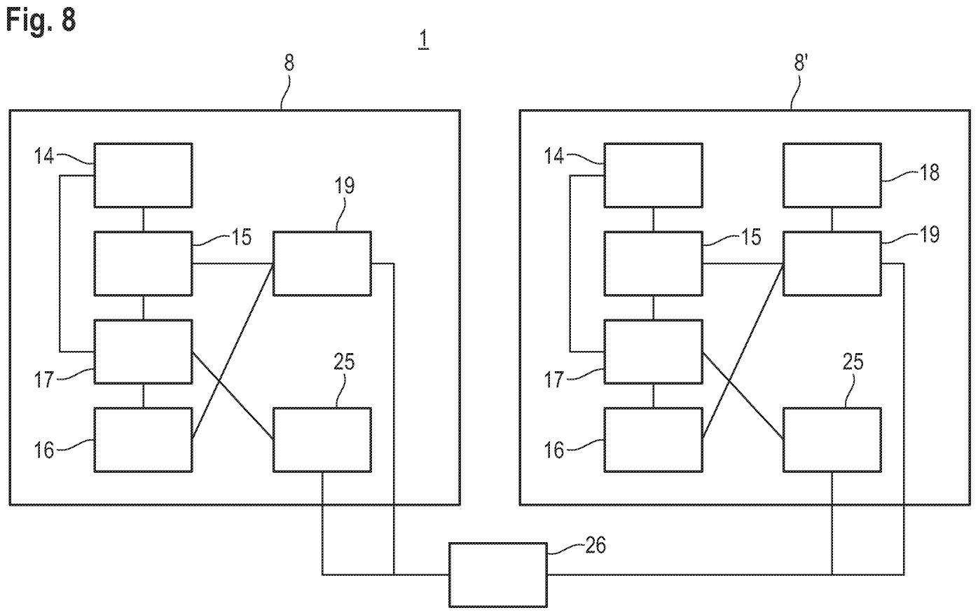

FIG. 8 shows a variant of the embodiment from FIG. 7. In this case, an RFID emulator user interface 18 is provided only in the RFID emulator software 8′ of an RFID emulator system 6′, which RFID emulator user interface 18 is used for both RFID emulator systems 6, 6′. A synchronization of the RFID emulator databases 17 is performed by means of the RFID emulator database synchronization modules 25.

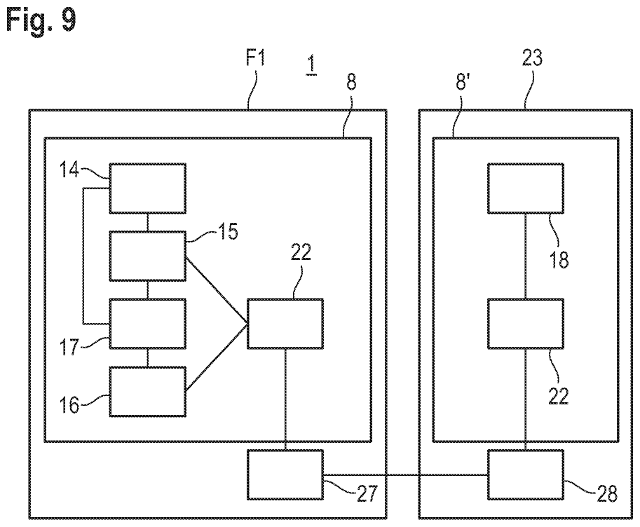

FIG. 9 shows yet another variant of a sensor array 1. An RFID emulator system 6 with RFID emulator sensors 2 (not shown) is arranged in a factory F1. The RFID emulator software 8 of this RFID emulator system 6 has an RFID emulator cloud connector 22 for connection to a firewall 27 in this factory F1. Here as well, the number of the RFID emulator systems 6, 6′ can vary.

From the firewall 27, a connection to a cloud system 23 proceeds via a cloud infrastructure 28 present therein. The connection to an RFID emulator software 8′ in the cloud system 23 takes place via an RFID emulator cloud connector 22 and an RFID emulator user interface 18.

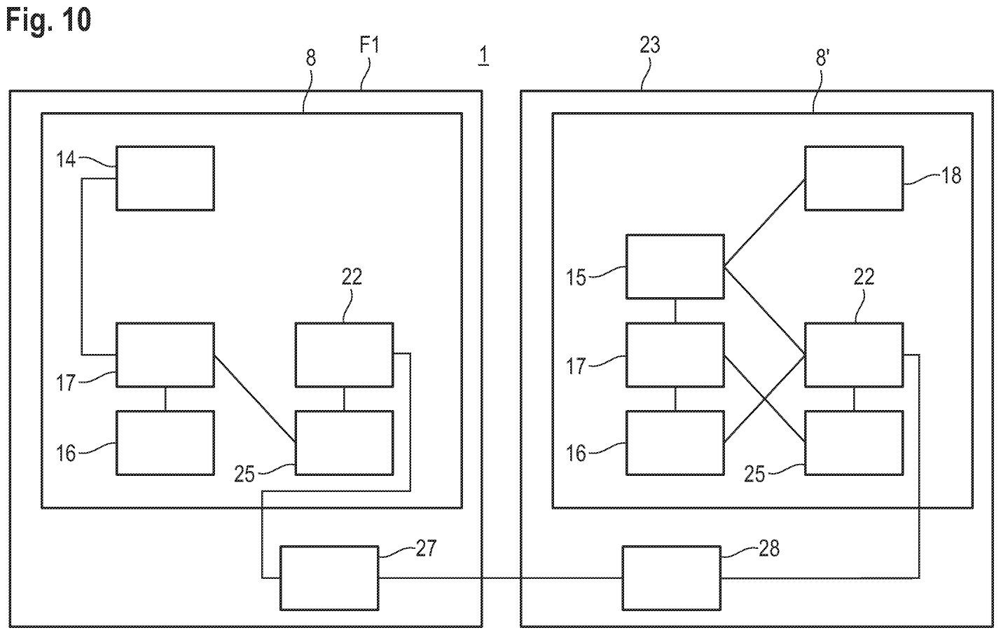

FIG. 10 shows an additional variant of a sensor array 1 that represents an extension of the embodiment according to FIG. 9 such that both in the RFID emulator software 8 of the factory F1 as well as in the RFID emulator software 8′ of the cloud system 23 an RFID emulator database synchronization module 25 is provided for synchronizing the RFID emulator databases 17.

### LIST OF REFERENCE NUMERALS

(1) sensor array
(2) RFID emulator sensor
(2a-2d) RFID emulator sensor
(3) code
(4, 4′) host system
(5) data cable
(6, 6′) RFID emulator system
(7, 7′) computing unit
(8, 8′) RFID emulator software
(9) emulator data channel
(9a, 9b) communication interface element
(10) code reader, additional
(11) network
(12) sensor
(13) multisensor interface
(14) transponder logic
(15) RFID emulator application logic
(16) RFID emulator sensor logic
(17) RFID emulator database
(18) RFID emulator user interface
(19) programming interface
(20) directory service
(21) external system
(22) RFID emulator cloud connector
(23) cloud system
(24) CRM system
(25) RFID emulator database synchronization module
(26) network router
(27) firewall
(28) cloud infrastructure
F1 factory
F2 factory

1. A sensor array (1) with at least one code reader that is designed for reading codes (3), and at least one computing unit (7), characterized in that the code reader with the computing unit (7) constitutes an RFID emulator sensor (2) in that they are connected via an emulator data channel (9), via which channel exclusively subsystem data and/or transponder emulator data can be written by the code reader to a memory range of a memory unit of the computing unit (7) or subsystem data and/or transponder emulator data can be read from this memory unit by means of the code reader, wherein this memory range is defined by a code (3) read by the code reader.

2. The sensor array (1) according to claim 1, characterized in that the transponder emulator data is object data.

3. The sensor array (1) according to claim 1, characterized in that the object data refers to an object that is labelled with a code (3), which is read by the code reader constituting the RFID emulator sensor 2.

4. The sensor array (1) according to claim 1, characterized in that the transponder emulator data is sensor data that is generated by sensors (12), which are assigned to the code reader constituting the RFID emulator sensor 2.

5. The sensor array (1) according to claim 1, characterized in that data of the code reader or the units assigned thereto are provided as subsystem data.

6. The sensor array (1) according to claim 1, characterized in that transponder emulator metadata is assigned to the transponder emulator data.

7. The sensor array (1) according to claim 1, characterized in that the memory unit can be segmented and scaled.

8. The sensor array (1) according to claim 1, characterized in that the memory unit constitutes a database.

9. The sensor array (1) according to claim 1, characterized in that the communication between the code reader constituting the RFID emulator sensor 2 and the computing unit (7) takes place via a secure communication interface.

10. The sensor array (1) according to claim 9, characterized in that the communication interface is designed for configuring various communication and security settings of the RFID emulator sensors (2, 2a-2d) and transponder emulator data.

11. The sensor array (1) according to claim 1, characterized in that a lock mechanism is provided as access protection for data stored in the memory unit.

12. The sensor array (1) according to claim 1, characterized in that it has multiple code readers that are assigned to a computing unit (7), wherein each code reader with the computing unit (7) constitutes an RFID emulator sensor (2).

13. The sensor array (1) according to claim 1, characterized in that it has multiple code readers that are assigned to various computing units, wherein each code reader with the assigned computing unit (7) constitutes an RFID emulator sensor (2).

14. The sensor array (1) according to claim 1, characterized in that the computing unit (7) or a computing unit (7) is a cloud computer, a server or a local computer of an automation plant.

15. The sensor array (1) according to claim 13, characterized in that the various computing units (7) are connected via network routers (26).

16. The sensor array (1) according to claim 13, characterized in that the various computing units (7) are connected via a cloud.

17. The sensor array (1) according to claim 13, characterized in that means for synchronizing the memory units or, respectively, the databases of the individual computing units (7) are provided.

18. The sensor array (1) according to claim 1, characterized in that multiple code readers constitute a multiscan arrangement.

19. The sensor array (1) according to claim 18, characterized in that a code (3) can be read simultaneously from different directions with the code readers of the multiscan arrangement, wherein these code readers are networked in a logic network (11) and only one of these code readers with the assigned computing unit (7) constitutes an RFID emulator sensor (2), and wherein the additional code readers of the multiscan arrangement are simultaneously triggered by means of the code reader constituting the RFID emulator sensor (2) to perform read operations of a code (3), and wherein the first code (3) read by one of the code readers is used for further processing.

20. The sensor array (1) according to claim 18, characterized in that multiple spaced codes (3) are read by the code readers of the multiscan arrangement.

21. The sensor array (1) according to claim 19, characterized in that the codes (3) have different start character strings but the same end character strings.

22. The sensor array (1) according to claim 20, characterized in that based on the read codes (3), a filtering is performed or an object orientation is determined.

23. The sensor array (1) according to claim 18, characterized in that different fragments of a code (3) are read by the code readers of the multiscan arrangement, wherein the fragments are compiled in an RFID emulator sensor (2) or in a computing unit (7, 7′) in order to capture the code (3).

24. The sensor array (1) according to claim 1, characterized in that an RFID emulator software (8) which constitutes a control and evaluation unit of the RFID emulator sensor is implemented in the computing unit (7) or in each computing unit (7).

25. The sensor array (1) according to claim 19, characterized in that an RFID emulator user interface (18) assigned to the RFID emulator software (8) is provided.

26. The sensor array (1) according to claim 20, characterized in that the RFID emulator software (8, 8′) and the RFID emulator user interface (18) are provided on different computing units (7, 7′).

27. The sensor array (1) according to claim 21, characterized in that the RFID emulator user interface (18) is provided in a cloud system (23).

28. The sensor array (1) according to claim 20, characterized in that access to transponder emulator data and/or transponder emulator metadata stored in a memory unit takes place by means of an RFID emulator application logic (15).

29. The sensor array (1) according to claim 20, characterized in that access to the RFID emulator software (8, 8′) is enabled via the RFID emulator user interface (18).

30. The sensor array (1) according to claim 24, characterized in that an addressing and/or an administration of the RFID emulator software (8, 8′) is enabled via the RFID emulator user interface (18).

31. The sensor array (1) according to claim 20, characterized in that transponder emulator data and/or transponder emulator metadata can be administered, archived, evaluated or replicated via an RFID emulator application logic (15).

32. The sensor array (1) according to claim 31, characterized in that a programming interface (19) is provided via which the RFID emulator application logic (15) can be addressed.

33. The sensor array (1) according to claim 25, characterized in that a capturing, configuration, diagnosis, monitoring and administration of the RFID emulator sensors (2, 2a-2d) is performed by means of the RFID emulator software (8, 8′).

34. The sensor array (1) according to claim 25, characterized in that an update of firmware or software units of RFID emulator sensors (2, 2a-2d) can be performed by means of the RFID emulator software (8, 8′).

35. The sensor array (1) according to claim 1, characterized in that it is connected to a host system (4).

36. The sensor array (1) according to claim 1, characterized in that it is secured by authentication mechanisms.
